(19) United States
(12) Patent Application Publication
(10) Pub. No.: US 2013/0036373 A1
(43) Pub. Date: Feb. 7, 2013

(54) Systems and Methods for Providing a Virtual Currency Exchange

(71) Applicants: Kimberly Alderfer, Hoboken, NJ (US); Luke Allan Arthur Gardiner, Suffolk (GB); Wayne Richard Gosling, Surrey (GB); Laila Mahernia, Brighton (GB)

(72) Inventors: Kimberly Alderfer, Hoboken, NJ (US); Luke Allan Arthur Gardiner, Suffolk (GB); Wayne Richard Gosling, Surrey (GB); Laila Mahernia, Brighton (GB)

(73) Assignee: AMERICAN EXPRESS TRAVEL RELATED SERVICES COMPANY, INC., New York (US)

(21) Appl. No.: 13/198,905

(22) Filed: Aug. 5, 2011

(51) Int. Cl. G06F 3/048

(52) U.S. Cl. 715/757

(57) ABSTRACT

A virtual world management system may access multiple virtual world programs. The virtual world management system is configured to transfer points between the system and at least one of the virtual world programs. A virtual world program may be any online game with membership accounts. The virtual world management system, in one embodiment, accesses the virtual world program with various limitations, allowing the virtual world management system to control, access, or edit only parts of the virtual world programs. For example, the access may be limited to viewing the information related to the membership accounts. Specifically, the virtual world management system may be limited to viewing individual account balances of the virtual world accounts. Furthermore, the limited access may allow transfer of points and/or limiting access of the user playing the online game. The points may be at least one of currency, membership points, reward points, or loyalty points.

### FIELD

The present disclosure generally relates to providing virtual currency exchange, and more particularly, to providing a virtual currency exchange for multiple virtual world programs from a common platform.

### BACKGROUND

A virtual economy is an emergent economy existing in a virtual persistent world, usually exchanging virtual items in the context of online gaming. The virtual worlds are usually online games provided by third party service providers. Over the last few years, there have been a drastic increase in the number of virtual worlds and the number of users/players associated with these virtual worlds. Each virtual world may have their own propriety payment capabilities and individual virtual currencies. Users/Players of the virtual world may use the virtual currencies to perform one or more financial transactions in the virtual world. These currencies may be available on exchange of real currencies such as US dollars, Euros etc based on an exchange rate.

However, the virtual currencies are not directly exchangeable between virtual worlds. Also, in situations when a player gets bored with or leaves a virtual world, he/she may want to redeem or transfer currency from one virtual world to another. There are solutions that offer exchange between virtual currencies and real currencies (commonly USD), but these solutions offer ad-hoc transfer and exchanges and also the multiple virtual world account may not be managed from a common platform.

Given the foregoing, an efficient virtual currency exchange is needed.

### SUMMARY

The present disclosure meets the above-identified need by providing methods, systems and non-transitory computer-readable medium for virtual currency exchange.

In one embodiment, a virtual world management system may access, using a computer based system, a first virtual world program. The virtual world management system may also access a second virtual world program. The virtual world management system is configured to transfer points between the system and at least one of the first or second virtual world programs. The first virtual world program is a first online game with membership accounts, including a first membership account. The second virtual world program is a second online game with membership accounts, including a second membership account. The first online game may be different than the second online game. However, it is also contemplated that the first online game is the same as the second online game, with multiple membership accounts.

The virtual world management system, in one embodiment, accesses the first or second virtual world program with various limitations. This allows the user of the virtual world management system to control, access, or edit only parts of the virtual world programs. For example, the access may be limited to viewing the information related to the membership accounts. Specifically, the virtual world management system may be limited to viewing individual account balances of the first virtual world and the second virtual world. In some respects, the limited access may allow transfer of points and/or limiting access of the user playing the online game. The points may be at least one of currency, membership points, reward points, or loyalty points. Additionally, the virtual world management system may be capable of exchanging multiple types of points using an exchange rate. In an exemplary embodiment, the virtual world management system logs a spending history of the individual account balances of the first virtual world and the second virtual world.

In various embodiments, the user of the virtual world management system performs a supervisory role of the membership accounts, and the online game users are separate from the user of the virtual world management system. For example, the supervisory role may be filled by a parent, and the membership accounts belong to a child. In another embodiment, the membership accounts belong to the same person who uses the virtual world management system to oversee multiple online gaming accounts.

In an exemplary embodiment, the virtual world management system is configured to automatically transfer points from the virtual world management system to the first virtual world program in response to a points value of the first membership account falling below a threshold value. In another embodiment, the virtual world management system is configured to transfer points from the virtual world management system to the first membership account of the first virtual world program based on a predetermined time period. The predetermined time period may be at least one of weekly, monthly, or based on duration of time spent logged-on to the first or second virtual world program. In yet another embodiment, the virtual world management system is configured to transfer points from the virtual world management system to the first virtual world program, wherein the amount of transferred points is a percentage of a total value stored in the virtual world management system.

In addition to the transferring of points or viewing of account information, the player-user may be notified of changes to the first membership account initiated by the virtual world management system user. The player-user may also be asked to confirm that the points have been successful transferred between accounts.

One feature of the interaction between the virtual world management system and the virtual world programs is authorized access. The virtual world management system may be authenticated prior to accessing the first virtual world program to assure only appropriate users have access. Various steps may be taken to perform this authorization. In an exemplary embodiment, the steps comprise receiving, by a computer based system, member-defined conditions for the multiple virtual world accounts, where the member-defined conditions place limits on use of the multiple virtual world accounts, and the further step of receiving, by the computer based system, manager-defined conditions for the multiple virtual world accounts, wherein the manager-defined conditions place limits on use of the multiple virtual world accounts at the virtual world management system. The method further includes initiating, by the computer based system, a transfer of points using at least one of the multiple virtual world accounts, and receiving, by the computer based system, an authorization request from the at least one of the first virtual world program or the second virtual world program, the authorization request including at least one individual virtual world account identifier. Also, the method may include determining, by the computer based system, whether the transfer satisfies the member-defined conditions and the manager-defined conditions, and authorizing, by the computer based system, the transaction if the member-defined conditions and the manager-defined conditions are satisfied. In one embodiment, denying, by the computer based system, the transaction if the member-defined conditions or the manager-defined conditions are not satisfied. At least one of the above steps is performed by a processor.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an exemplary environment in which virtual world management system for providing virtual currency exchange may be deployed, according to an exemplary embodiment;

FIG. 2 is an exemplary implementation of the virtual world management system for providing virtual currency exchange, according to an exemplary embodiment;

FIG. 3 illustrates an online interface representing the virtual world management system, according to an exemplary embodiment;

FIG. 4 illustrates a tab in the online interface representing the virtual world management system, according to an exemplary embodiment;

FIG. 5 illustrates another tab in the online interface representing the virtual world management system, according to an exemplary embodiment;

FIG. 6 illustrates another tab in the online interface representing the virtual world management system, according to an exemplary embodiment;

FIG. 7 is a flowchart illustrating one example process for providing virtual currency exchange, according to an exemplary embodiment; and

FIG. 8 is a block diagram of an exemplary computer system, according to an exemplary embodiment.

### DETAILED DESCRIPTION

The detailed description of exemplary embodiments herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented. Moreover, any singular term shall also include more than one, and any plural term shall include one item.

The present exemplary embodiments are described herein with reference to system architecture, block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

A “consumer”, as used herein, may include any individual, business, entity, group, charity, software and/or hardware that have a transaction account associated with an issuer. It is noted that the terms “customer,” “consumer,” “transaction account holders”, “user” and “population” are used interchangeably herein. Further, the transaction account holder may include a user that controls an account, a beneficiary of an account, someone associated with an account, and/or someone that has the right to use an account.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments of disclosure are embodied in a system and method for virtual currency exchange. The nomenclature “virtual currency exchange” is only exemplary and used for descriptive purposes, and must not be construed to limit the scope of the present disclosure.

The present disclosure is now described in more detail herein in terms of the above disclosed exemplary embodiments of system, processes and computer program products. This is for convenience only and is not intended to limit the application of the present disclosure. In fact, after reading the following description, it will be apparent to one skilled in the relevant art(s) how to implement the following disclosure in alternative embodiments.

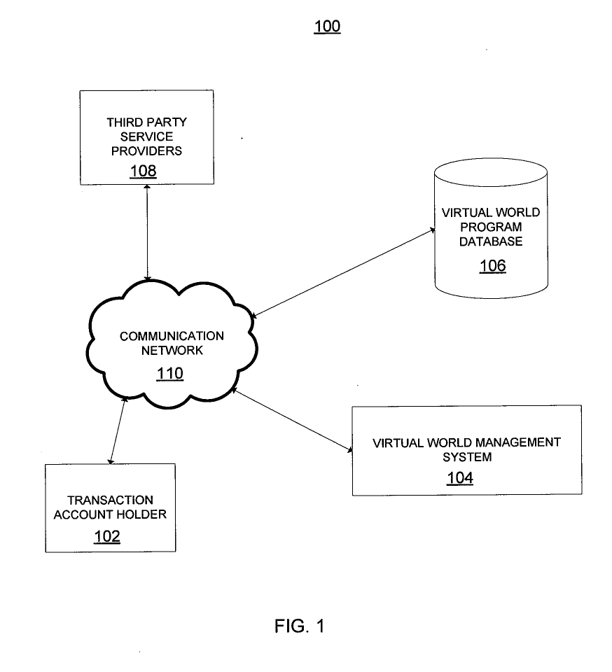

FIG. 1 shows an exemplary environment 100 in which the present disclosure may be utilized. Environment 100 includes at least one transaction account holder 102, a virtual world management system 104, a virtual world program database 106, third party service providers 108, and a communication network 110. Transaction account holder 102, virtual world management system 104, virtual world program database 106, and third party service providers 108 may communicate with each other over communication network 110. Examples of communication network 110 may include a wide area network (WAN), a local area network (LAN), an Ethernet, Internet, an Intranet, a cellular network, a satellite network, or any other suitable network for transmitting data. Communication network 110 may be implemented as a wired network, a wireless network or a combination thereof.

As used herein, the term “network” may also include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any items over any network having similar functionality described herein.

Phrases and terms similar to an “item” or “point” may include any good, service, information, experience, data, content, access, rental, lease, contribution, account, credit, debit, benefit, right, reward, points, coupons, credits, loaned points, monetary equivalent, anything of value, something of minimal or no value, monetary value, non-monetary value and/or the like.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety. The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Transaction account holder 102 may hold any financial transaction accounts. The transaction account may exist in a physical or non-physical embodiment. For example, a transaction account may be distributed in non-physical embodiments such as an account number, frequent-flyer account, telephone calling account, or the like. Furthermore, a physical embodiment of a transaction account may be distributed as a financial instrument. Transaction account holder 102 may be provided the facility of online or internet banking where transaction account holder 102 may conduct financial transactions on a secure website operated by an issuer of the transaction account or a third party affiliated with the issuer. For example, financial transactions may include account to account transfer, paying a bill, wire transfer, apply for a loan or new account, investment purchase or sale, viewing recent transactions, management of multiple users having varying levels of authority, transaction approval process and the like. Transaction account holder 102 may be provided with one or multiple levels of authentication to process a financial transaction through online banking.

In an exemplary implementation as shown in FIG. 1, virtual world management system 104 may be communicatively coupled with transaction account holder 102 through communication network 110. Further, virtual world program database 106 and third party service providers 108 may be communicably coupled with virtual world management system 104 via communication network 110 discussed herein. Virtual world program database 106 and third party service providers 108 may include any device (e.g., personal computer). These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that virtual world program database 106 and third party service providers 108 may or may not be in direct contact with virtual world management system 104. In an embodiment, virtual world program database 106 may be managed and updated by virtual world management system 104. In another embodiment, virtual world program database 106 may be managed and updated by third party service providers 108. Also, virtual world management system 104 may access the services of virtual world program database 106 and third party service providers 108 through another server, which may have a direct or indirect connection with communication network 110.

In one embodiment, virtual world management system 104 may be deployed as a separate entity on a third party server. In another embodiment, virtual world management system 104 may be deployed on one or more servers associated with the issuer of the transaction account associated with the transaction account holder 102. Although virtual world management system 104 is described herein in terms of providing virtual currency exchange, it will be readily apparent to one skilled in the art that a similar virtual world management system may be deployed for other types of products/services such as, for example, offering financial transaction instruments, open transaction instruments, loans, insurance plans, travel packages, retail goods and the like.

In an exemplary embodiment, virtual world management system 104 may be configured to access one or more virtual world programs and transfer points between accounts associated with one or more virtual world programs and virtual world management system 104. Virtual world management system 104 may be further configured to transfer or exchange the points between the accounts associated with one or more virtual world programs based on one or more pre-defined conditions. For example, pre-defined conditions may include points falling below a threshold value, a points to be transferred after a predetermined time period, points to be transferred is a percentage of a total number of points stored in virtual world management system 104, points value based on a pre-defined exchange rate, and the like. Further, virtual world management system 104 may also allow transaction account holders 102 to view individual account balances associated with virtual world programs. Moreover, virtual world management system 104 may log a spending history associated with the virtual world programs. In an embodiment, virtual world management system 104 may be authenticated prior to accessing the one or more virtual world programs to assure only appropriate users have access to virtual world management system. The authentication may include satisfying member-defined conditions and manager-defined conditions, where member may include users associated with the one or more virtual world programs and manager may include user associated with virtual world management system. In one embodiment, virtual world management system 104 may utilize services of third party service providers 108 and the virtual world program database 106 to provide virtual currency exchange.

Third party service providers 108 may include, for example, virtual world program providers such as online games, online games software, online service providers and the like. Third party service providers 108 may be adapted to design and provide online gaming platform to one or more users. Examples of virtual world programs may include Second Life, IMVU, Frenzoo, Toribash, Friendshangout, Farmville, Club Penguin, Barbie Girls, World of Warcraft, etc. The virtual world programs may allow various users to interact with each other in the virtual world programs. For example, the virtual world program “Second Life” is an online virtual world developed by Linden Lab. A number of free client programs called viewers may enable Second Life users, called Residents, to interact with each other through avatars. Residents may explore the world (known as the grid), meet other residents, socialize, participate in individual and group activities, and create and trade virtual property and services with one another. Generally, such virtual world programs may have an individual internal economy and internal virtual currency for trading virtual property and services. For example, the virtual world program Second Life has an internal economy and internal currency, the Linden dollar (L$). L$ may be used to buy, sell, rent or trade virtual lands, goods and services with the users of the virtual world program Second Life. Virtual goods may include buildings, vehicles, animated objects, clothing, skin, hair, jewelry, flora and fauna, works of art and the like. Virtual services may include camping, wage labor, business management, entertainment and custom content creation. The virtual currencies may be purchased using real currencies such as dollars, euros, pounds and the like on market-based currency exchanges. For example, Linden dollar, the virtual currency for virtual world program “Second Life” may be purchased using US Dollars and other currencies on LindeX exchange, independent brokers or other resident users on market-based currency exchanges.

In an exemplary embodiment, third party service providers 108 may have a business relationship with the issuer of the of virtual world management system 104. The business relationship may include, for example, a financial contract between the issuer and third party service providers 108.

In one embodiment, virtual world program database 106 may include one or more information associated with the virtual world programs. Examples of the information may include, information associated with the user of the virtual world program, membership account information of the user of the virtual world program, virtual currency used in the virtual world programs and corresponding exchange rates and the like. In an exemplary embodiment, third party providers 108 may update the information in virtual world program database 106. In one embodiment, virtual world program database 106 may be an integral component of virtual world management system 104. In such event, transaction account holder 102 associated with virtual world management system 104 may update information in virtual world program database 110. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the embodiment, any suitable data storage technique may be utilized to store data without a standard format. Data sets may be stored using any suitable technique, including, for example, storing individual files using an ISO/DEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using one of fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of virtual world program database 110, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer (operator of virtual world management system 104), customers or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate. The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. Virtual world program database 110 contemplates a data storage arrangement wherein the header or trailer, or header or trailer history, of the data is stored on the transaction instrument in relation to the appropriate data. One skilled in the art will also appreciate that, for security reasons, any databases, systems, devices, servers or other components of virtual world program database 110 may consist of any combination thereof at a single location or at multiple locations, wherein each database or system includes any of various suitable security features, such as firewalls, access codes, encryption, decryption, compression, decompression, and/or the like.

The embodiments may be described herein in terms of functional block components, screen shots, optional selections and various processing steps. It should be appreciated that such functional blocks may be realized by any number of hardware and/or software components configured to perform the specified functions. For example, system/environment 100 may employ various integrated circuit components, e.g., memory elements, processing elements, logic elements, look-up tables, and/or the like, which may carry out a variety of functions under the control of one or more microprocessors or other control devices. Similarly, the software elements of system/environment 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system/environment 100 may employ any number of conventional techniques for data transmission, signaling, data processing, network control, and/or the like. Still further, system/environment 100 could be used to detect or prevent security issues with a client-side scripting language, such as JavaScript, VBScript or the like.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

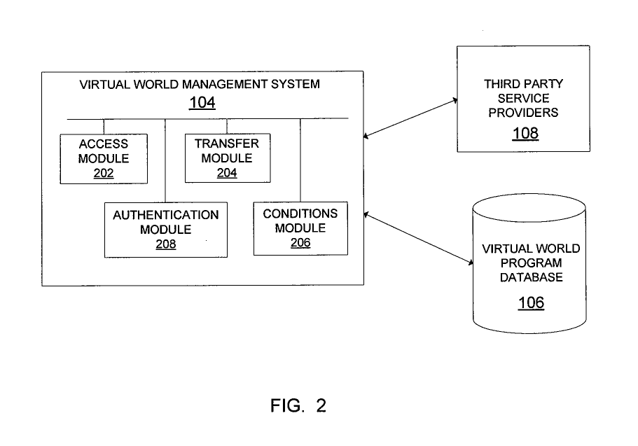

Referring to FIG. 2, an exemplary implementation of virtual world management system 104 is depicted. As shown in the exemplary embodiment of FIG. 2, virtual world management system 104 may include an access module 202, a transfer module 204, an authentication module 206, and a condition module 208.

Virtual world management system 104 may be configured to communicate with third party service providers 108 and virtual world program database 106 through communication network 110. In an exemplary embodiment, virtual world management system 104 may be an online interface that may be offered to transaction account holder 102 to manage virtual world programs through virtual world management system 104. The virtual world programs may include online games as explained in FIG. 1. For the sake of simplicity, the exemplary embodiment has considered two virtual world programs: a first virtual world program and a second virtual world program to be associated with virtual world management system 104. However, it is apparent to a person who is ordinarily skilled in the art that the number of virtual world programs to be associated with virtual world management system 104 does not limit the scope of the embodiments described herein.

In an embodiment, transaction account holder 102 may create a profile on virtual world management system 104. Transaction account holder 102 may add information related to the multiple virtual world programs, for example, the first virtual world program and the second virtual world program in virtual world management system 104. In one embodiment, the information may be stored in virtual world program database 106. The information may include the information such as membership account information associated with the first and second virtual world programs, virtual currency associated with these programs, currency exchange rates and the like.

In an embodiment, transaction account holder 102 may access the first virtual world program through access module 202 of virtual world management system 104. The first virtual world program may be a first online game with multiple membership accounts associated with one or more users. Transaction account holder 102 may also access the second virtual world program through access module 202. The second virtual world program may be a second online game with multiple membership accounts associated with one or more users. In an embodiment, the first online game may be different than the second online game having multiple membership accounts associated with different users. In one embodiment, the first online game may be different than the second online game having multiple membership accounts associated with same users. However, in another embodiment, it may also be contemplated that the first online game may be the same as the second online game but having multiple membership accounts associated with different users.

In an embodiment, transaction account holder 102 may be registered with virtual world management system 104 and is different from the users registered with the virtual world programs. Thus, in this embodiment, the first online game may be registered to a first user and the virtual world management system 104 may be registered to a second user (transaction account holder 102) who is different from the first user. In various embodiments, the user of virtual world management system 104 may perform a supervisory role of the membership accounts of other users associated with the virtual world programs and the users of the virtual world programs are different than that of virtual world management system 104. For example, the supervisory role may belong to a parent and the membership accounts may belong to children. In another embodiment, the first user may be same as the second user or the membership accounts may belong to the same user who may use virtual world management system 104 to manage one or more virtual world programs.

In an embodiment, virtual world management system 104 may provide limited access to the membership accounts associated with the virtual world programs. For example, if the first online game has a first membership account and the second online game has a second membership account, then transaction account holder 102 may access the first and the second membership accounts, through virtual world management system 104, but with various limitations. The limitations may allow transaction account holder 102 or the user of virtual world management system 104 to control, access or edit only parts of the virtual world programs. For example, the limitations may include viewing information related to the membership accounts. Specifically, user of virtual world management system 104 may be limited to viewing individual balances of the virtual world programs. In various embodiments, the limited access may allow to transfer points between the membership accounts associated with the virtual world programs and the account associated with virtual world management system 104. Transaction account holder 102 may transfer points between the accounts of virtual world management system 104 and at least one of the first or second virtual world programs through transfer module 204 of virtual world management system 104. Transaction account holder 102 may debit the points from the account of virtual world management system 104 and credit the points in the account associated with the first virtual world program or vice-versa. Similarly, transaction account holder 102 may debit the points from the account of virtual world management system 104 and credit the points in the account associated with the second virtual world program or vice-versa.

The points associated with the virtual world programs may include the virtual currencies associated with the virtual world programs. For example, the virtual world program “Second Life” has the virtual currency “Linden Dollars”. The virtual currencies may be purchased against the real currencies such as US Dollars, Euros and the like. The virtual currencies may also be purchased against the rewards points, membership points, loyalty points and the like that may have been accumulated in the transaction account associated with transaction account holder 102. The transaction account may be the same account that may be associated with virtual world management system 104. These points may have been accumulated from the financial transaction that has been conducted by transaction account holder 102. Transaction account holder 102 may associate these points with virtual world management system 104 and may use these points to purchase the virtual currencies associated with the virtual world programs. In an embodiment, the virtual currencies may also be transferred from the accounts associated with the virtual world programs to the account of virtual world management system 104 in the form of real currencies, membership points, reward points, loyalty points and the like. In one embodiment, the virtual currency may be transferred from one virtual world program to virtual world management system 104 in the form of another virtual currency that may be utilized in another virtual world program.

Further, virtual world management system 104 may be configured to exchange real currencies such as Dollars, Euros for the virtual currencies using an exchange rate. Virtual world management system 104 may also be configured to exchange reward points, membership points, loyalty points and the like for the virtual currencies using an exchange rate. Similarly, virtual world management system 104 may also be configured to exchange the virtual currencies for real currencies, reward points, loyalty points and the like using the exchange rate. The exchange rate may vary for buying and selling the virtual currencies associated with the virtual world programs.

In an embodiment, there may be one or more pre-defined conditions stored in conditions module 206 of virtual world management system 104 for transferring the points between the accounts of virtual world management system 104 and the accounts of the at least one of the first world program and the second world program. The pre-defined conditions may be either member-defined conditions or the manager-defined conditions. The member-defined conditions may include the limited access on the use of the membership accounts associated with the one or more virtual world programs. For example, user (member-defined) of the virtual world programs may place a limit on the amount of points to be transferred from the virtual world program. The manager-defined conditions may place limits on the use of the membership accounts of the virtual world programs at virtual world management system 104. Specifically, transaction account holder 102 (manager-defined) may place one or more conditions based on which the transfer of points may take place from the one or more virtual world programs.

For example, the one or more conditions may include transferring points on fixed intervals, transferring points based on a percentage of total points available in the account of virtual world management system 104 and the like. In an exemplary embodiment, virtual world management system 104 may be configured to automatically transfer points to the virtual world programs if the points in the membership account of a specific virtual world program may fall below a pre-determined threshold value. In another exemplary embodiment, virtual world management system 104 may be configured to transfer points to the membership account of a specific virtual world program based on a pre-determined time period such as weekly, monthly, or based on duration of time spent logged-on to that virtual world program. In another exemplary embodiment, virtual world management system 104 may be configured to transfer points to the virtual world programs based on a percentage of total value of points stored in the account of the virtual world management system 104.

In an embodiment, transaction account holder 102 may view, at virtual world management system 104, individual account balances of the virtual world programs added to virtual world management system 104. Further, virtual world management system 104 may also maintain a log of the spending history of the individual account balances of the virtual world programs.

In an embodiment, virtual world management system 104 may inform the user of the virtual world programs about the changes in the membership account that may be initiated by the user (transaction account holder 102) of virtual world management system 104. For example, virtual world management system 104 may send out an automatic notification to the user of the first virtual world program in response to a change in the membership account of the first virtual world program that may be initiated by transaction account holder 102. The change in the first membership account may include transfer of points to the membership account of the first virtual world program. Further, virtual world management system 104 may be configured to ask the user of the virtual world program for a confirmation that the points have been successfully transferred between the accounts of virtual world management system 104 and the virtual world programs. In an embodiment, the automatic notification may include a link for the user of the first virtual world program to confirm that the points have been successfully transferred.

In an embodiment, virtual world management system 104 may be authenticated, using an authentication module 208 of virtual world management system 104, prior to accessing the virtual world programs. Virtual world management system 104 may be authenticated to assure that only appropriate users have access to system 104 and the virtual world programs. For example, only a transaction account holder 102 associated with virtual world management system 104 may conduct one or more changes in the membership accounts of the virtual world programs. Also, the changes that may be conducted in the one or more virtual world programs may be limited based on one or more conditions defined by the corresponding users of the one or more virtual world programs.

In an embodiment, access module 202 may receive member-defined conditions for the membership accounts associated with the one or more virtual world programs. The member-defined conditions may be received from one or more user of the virtual world programs and the conditions may place limit on the use of the membership accounts associated with the virtual world programs. For example, the conditions may include a pre-defined percentage of the points to be transferred, the frequency in which the accounts may be accessed, and the like. Further, access module 202 may receive manager-defined conditions for the membership accounts associated with the one or more virtual world programs. The manager-defined conditions may be received by the user (transaction account holder 102) of virtual world management system 104 and the conditions may place limit on the use of the membership accounts associated with the virtual world programs at virtual world management system 104. For example, the conditions may include transfer of points only after a fixed interval, or if the points fall below a certain threshold, transfer points based on the amount of points available in the account of virtual world management system 104 and the like. Transfer module 204 may initiate the transfer of points between the accounts of virtual world management system 104 and at least one of the virtual world programs. However, in an embodiment, virtual world management system 104 may receive an authorization request from the virtual world program with which the points transfer is initiated. The authorization request may include at least one individual identifier for the membership account associated with the virtual world program. The identifier may include an alpha numeric key, a barcode scanner and the like. In response to the successful authorization, authentication module 208 of virtual world management system 104 may determine if the transfer of points satisfies both the manager-defined conditions and the member-defined conditions. Authentication module 208 may authorize the transaction of points transfer if the member-defined conditions and the manage-defined conditions may be satisfied. In another event, if the member-defined conditions and the manage-defined conditions are not satisfied, authentication module 208 may deny the transaction.

Virtual world management system 104 may act as a tool for providing efficient currency exchange between real currencies, reward points, membership points, loyalty points in the account associated with virtual world management system 104 and the virtual currencies associated with virtual world programs. Further, virtual world management system 104 may be associated with a parent and thus, the parent may have a supervisory role over the children who have their accounts with one or more virtual world programs. Virtual world management system 104 may be configured to either set up a recurring deposit to the accounts associated with the one or more virtual world programs, or transfer the points based on a number of points available in either account of virtual world management system 104 or the accounts associated with the one or more virtual world programs.

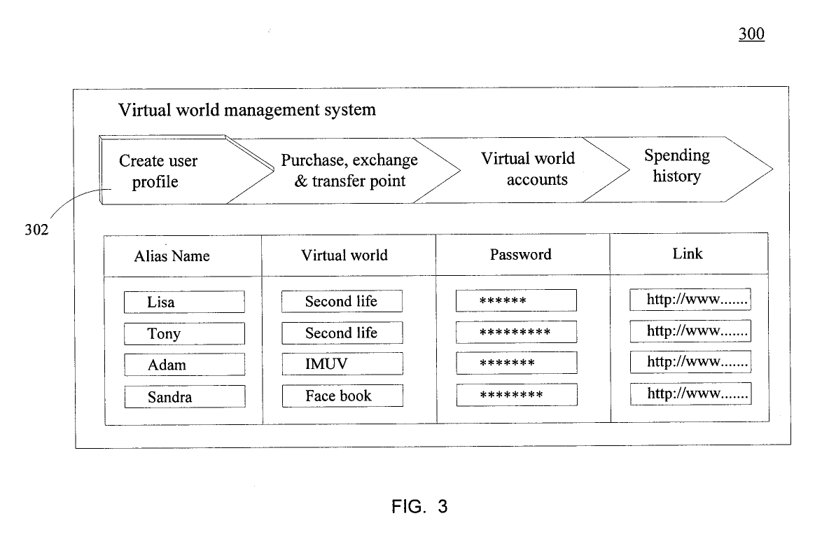

FIG. 3 is online interface 300 representing virtual world management system 104. In an embodiment, transaction account holder 102 may create a profile, using a create profile tab 302, in virtual world management system 104. Transaction account holder 102 may add information related to the multiple virtual world programs to be associated with virtual world management system 104. The information may include alias name (user name), virtual world program name, virtual world program identifier such as password, a link to the virtual world program. In an embodiment, the password may be used to authenticate transaction account holder 102 before initiation of transfer of points between the accounts of virtual world management system 104 and the virtual world programs. Transaction account holder 102 may also provide additional information, such as virtual currencies associated with virtual world programs, exchange rate and the like.

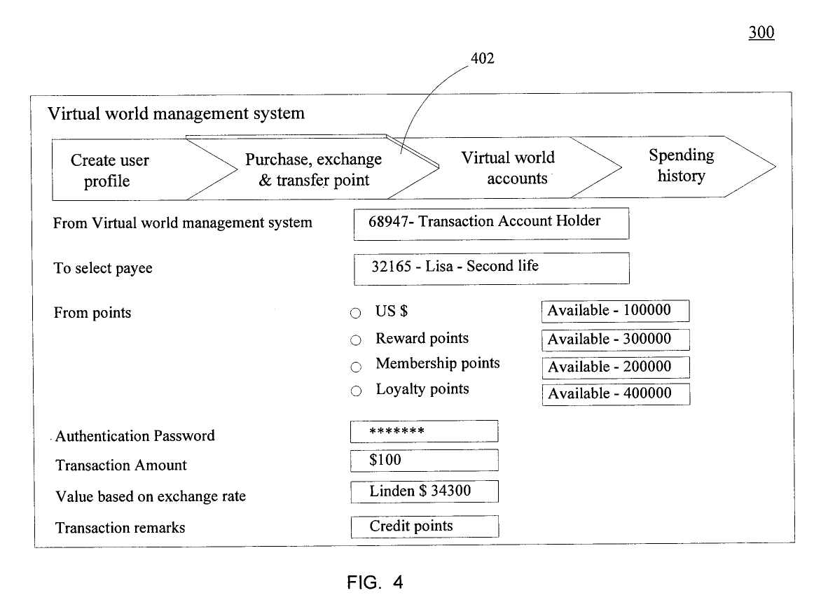

FIG. 4 illustrates purchase, exchange and transfer point tab 402 in online interface 300 representing virtual world management system 104. In an embodiment, transaction account holder 102 may transfer points from the account of virtual world management system 104 to the account of the virtual world program. Online interface 300 representing virtual management system 104 may be configured to enable transaction account holder 102 to select the account associated with the virtual world program to initiate the transfer of points. As illustrated in the exemplary embodiment of FIG. 4, transaction account holder 102 may transfer points from the account of virtual world management system 104 to the account of the virtual world program “Second Life” associated with user “Lisa”. Virtual world management system 104 may also allow transaction account holder 102 to select the kind of points. For example, the points may include real currencies such as US dollars, or points such as membership points, reward points, loyalty points and the like. In the exemplary embodiment of FIG. 4, transaction account holder 102 has selected SU dollars to transfer in the form of virtual currency “Linden Dollars” to the virtual world program “Second Life” based on a specified exchange rate. In an embodiment, on initiation of the points transfer, transaction account holder 102 may also provide a password to authenticate as an appropriate user of virtual world management system 102.

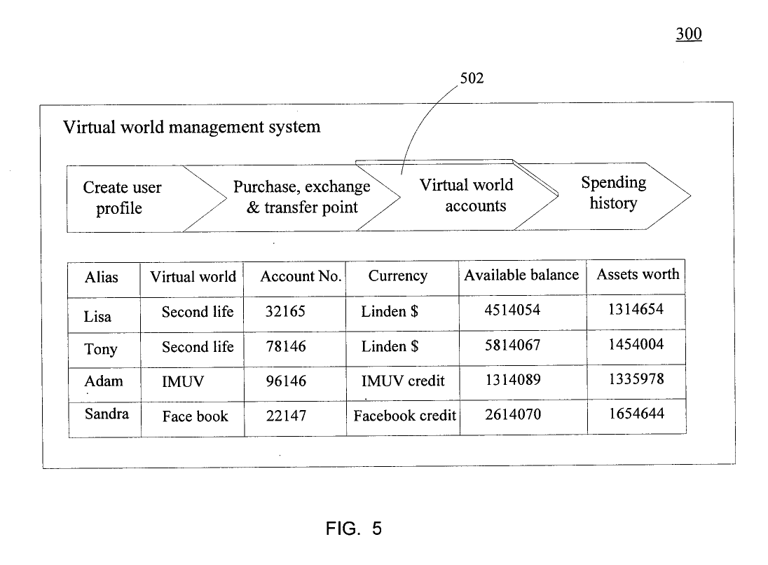

FIG. 5 illustrates virtual world accounts tab 502 in online interface 300 representing virtual world management system 104. Virtual world accounts tab 502 may provide one or more details of the virtual world programs associated with virtual world management system 104. As illustrated in the exemplary embodiment of FIG. 5, virtual world accounts tab 502 may provide information such as user name and corresponding virtual world programs, account numbers associated with virtual world program, virtual currencies, available balances, and virtual assets cost, In an embodiment, transaction account holder 102 may view the individual balances of the accounts associated with the individual virtual world programs through virtual world accounts tab 502.

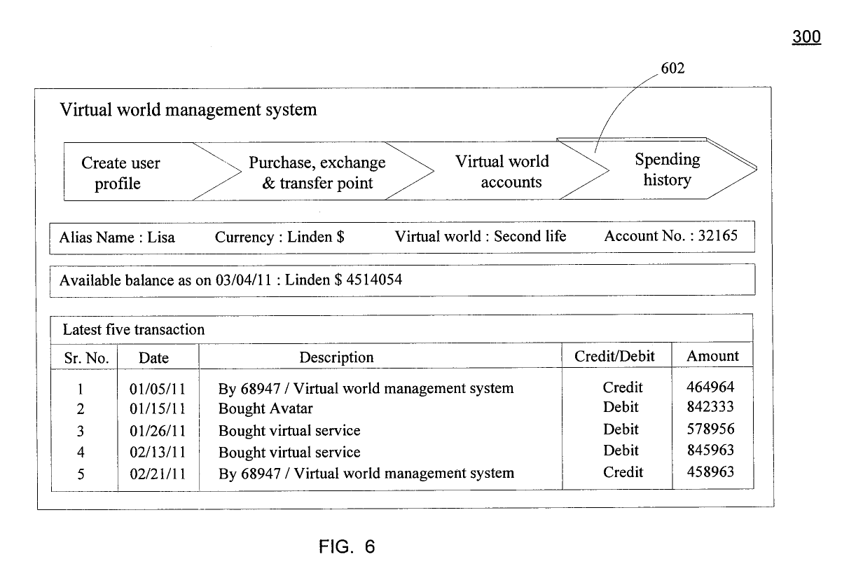

FIG. 6 illustrates spending history tab 602 in online interface 300 representing virtual world management system 104. In an embodiment, transaction account holder 102 may select any account of the virtual world programs associated with virtual world management system 104 to view a log of the spending history associated with the account. In the exemplary embodiment of FIG. 6, transaction account holder may have selected the account associated with virtual world program “Second Life” of the user “Lisa”. Spending history tab 602 may provide the user information, the selected virtual world program, associated currency and the account number. Further, tab 602 may also provide the latest five transactions from the account associated with the selected virtual world program.

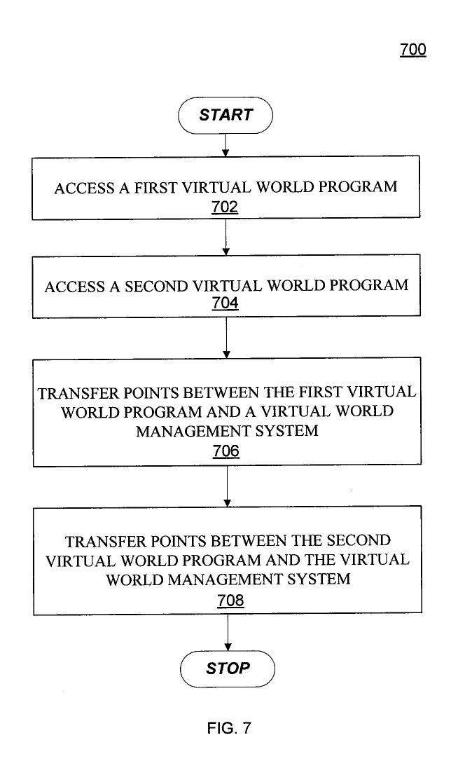

FIG. 7 is a flowchart illustrating an example process 700 for virtual currency exchange. In an embodiment, virtual world management system 104 may be an online interface that may be offered to transaction account holder 102 to manage virtual world programs through virtual world management system 104. The virtual world programs may include online games. For the sake of simplicity, the exemplary embodiment has considered two virtual world programs: a first virtual world program and a second virtual world program to be associated with virtual world management system 104. However, it is apparent to a person who is ordinarily skilled in the art that the number of virtual world programs to be associated with virtual world management system 104 does not limit the scope of the embodiments described herein.

In an embodiment, transaction account holder 102 may create a profile on virtual world management system 104. Transaction account holder 102 may add information related to the first virtual world program and the second virtual world program in virtual world management system 104. The information may include the information such as membership account information associated with the first and second virtual world programs, virtual currency associated with these programs, currency exchange rates and the like.

In an embodiment, transaction account holder 102 may access the first virtual world program through virtual world management system 104 (step 702). The first virtual world program may be a first online game with multiple membership accounts associated with one or more users. Transaction account holder 102 may also access the second virtual world program through virtual world management system (step 704). The second virtual world program may be a second online game with multiple membership accounts associated with one or more users. In an embodiment, the first online game may be different than the second online game having multiple membership accounts associated with different users. In one embodiment, the first online game may be different than the second online game having multiple membership accounts associated with same users. However, in another embodiment, it may also be contemplated that the first online game may be the same as the second online game but having multiple membership accounts associated with different users.

In an embodiment, transaction account holder 102 may be registered with virtual world management system 104 and is different from the users registered with the first and the second virtual world programs. In another embodiment, transaction account holder 102 may be same as at least one the users registered with the first or the second virtual world programs that may use virtual world management system 104 to manage the first and second virtual world programs.

In an embodiment, virtual world management system 104 may provide limited access to the membership accounts associated with the virtual world programs. The limitations may allow transaction account holder 102 or the user of virtual world management system 104 to control, access, or edit only parts of the virtual world programs. Specifically, transaction account holder 102 may be limited to viewing individual balances of the first and the second virtual world programs through virtual world management system 104. In various embodiments, the limited access may allow to transfer points between the membership accounts associated with the virtual world programs and the account associated with virtual world management system 104. Transaction account holder 102 may transfer points between the account of virtual world management system 104 and the first virtual world program through online interface 300 provided by virtual world management system 104 (step 706). Similarly, transaction account holder 102 may transfer points between the account of virtual world management system 104 and the second virtual world program through online interface 300 provided by virtual world management system 104 (step 708).

The points associated with the virtual world programs may include the virtual currencies associated with the virtual world programs. The virtual currencies may be purchased against the real currencies such as US Dollars, Euros and the like. The virtual currencies may also be purchased against the rewards points, membership points, loyalty points and the like that may have been accumulated in the transaction account associated with transaction account holder 102. The transaction account may be the same account that may be associated with virtual world management system 104. Further, virtual world management system 104 may be configured to exchange real currencies such as Dollars, Euros for the virtual currencies using an exchange rate. Virtual world management system 104 may also be configured to exchange reward points, membership points, loyalty points and the like for the virtual currencies using an exchange rate. The exchange rate may vary for buying and selling the virtual currencies associated with the virtual world programs.

In an embodiment, there may be one or more pre-defined conditions stored in conditions module 206 of virtual world management system 104 for transferring the points between the accounts of virtual world management system 104 and the accounts of the at least one of the first world program and the second world program. The pre-defined conditions may be either member-defined conditions or the manager-defined conditions. The member-defined conditions may include the limited access on the use of the membership accounts associated with the one or more virtual world programs. For example, user (member-defined) of the virtual world programs may place a limit on the amount of points to be transferred from the virtual world program. The manager-defined conditions may place limits on the use of the membership accounts of the virtual world programs at virtual world management system 104. Specifically, transaction account holder 102 (manager-defined) may place one or more conditions based on which the transfer of points may take place from the one or more virtual world programs.

In an exemplary embodiment, virtual world management system 104 may be configured to automatically transfer points to the virtual world programs if the points in the membership account of a specific virtual world program may fall below a pre-determined threshold value. In another exemplary embodiment, virtual world management system 104 may be configured to transfer points to the membership account of a specific virtual world program based on a pre-determined time period such as weekly, monthly, or based on duration of time spent logged-on to that virtual world program. In another exemplary embodiment, virtual world management system 104 may be configured to transfer points to the virtual world programs based on a percentage of total value of points stored in the account of the virtual world management system 104.

In another embodiment, transaction account holder 102 may view, at virtual world management system 104, individual account balances of the virtual world programs added to virtual world management system 104. Further, virtual world management system 104 may also maintain a log of the spending history of the individual account balances of the virtual world programs.

In an embodiment, virtual world management system 104 may inform the user of the virtual world programs about the changes in the membership account that may be initiated by the user (transaction account holder 102) of virtual world management system 104. The change in the first membership account may include transfer of points to the membership account of the first virtual world program. Further, virtual world management system 104 may be configured to ask the user of the virtual world program for a confirmation that the points have been successfully transferred between the accounts of virtual world management system 104 and the virtual world programs.

In an embodiment, virtual world management system 104 may be authenticated prior to accessing the virtual world programs. Virtual world management system 104 may be authenticated to assure that only appropriate users have access to system 104 and the virtual world programs. Also, the changes that may be conducted in the one or more virtual world programs may be limited based on one or more conditions defined by the corresponding users of the one or more virtual world programs.

In an embodiment, virtual world management system 104 may receive member-defined conditions for the membership accounts associated with the one or more virtual world programs. Further, virtual world management system 104 may receive manager-defined conditions for the membership accounts associated with the one or more virtual world programs. Virtual world management system 104 may initiate the transfer of points between the accounts of virtual world management system 104 and at least one of the first and the second virtual world programs. However, in an embodiment, virtual world management system 104 may receive an authorization request from at least one of the first and the second virtual world programs with which the points transfer is initiated. The authorization request may include at least one individual identifier for the membership account associated with the virtual world program. In response to the successful authorization, virtual world management system 104 may determine if the transfer of points satisfies both the manager-defined conditions and the member-defined conditions. Virtual world management system 104 may authorize the transaction of points transfer if the member-defined conditions and the manage-defined conditions may be satisfied. In another event, if the member-defined conditions and the manage-defined conditions are not satisfied, authentication module 208 may deny the transaction.

While the steps outlined above represent a specific embodiment, practitioners will appreciate that there are any number of computing algorithms and user interfaces that may be applied to create similar results. The steps are presented for the sake of explanation only and are not intended to limit the scope of the embodiments described herein in any way.

The embodiments disclosed herein (i.e., virtual world management system 104, process 700, any part(s) or function(s) thereof) may be implemented using hardware, software or a combination thereof, and may be implemented in one or more computer systems or other processing systems. However, the manipulations performed by the embodiments were often referred to in terms, such as comparing or checking, which are commonly associated with mental operations performed by a human operator. No such capability of a human operator is necessary, or desirable in most cases, in any of the operations described herein, which form a part of the disclosed embodiments. Rather, the operations are machine operations. Useful machines for performing the operations in the embodiments may include general-purpose digital computers or similar devices. In fact, at least one exemplary embodiment is directed towards one or more computer systems capable of carrying out the functionality described herein.

The computer system 800 includes at least one processor, such as a processor 802. Processor 802 is connected to a communication infrastructure 804, for example, a communications bus, a cross over bar, a network, and the like. Various software embodiments are described in terms of this exemplary computer system 800. After reading this description, it will become apparent to a person skilled in the relevant art(s) how to implement the present embodiments using other computer systems and/or architectures.

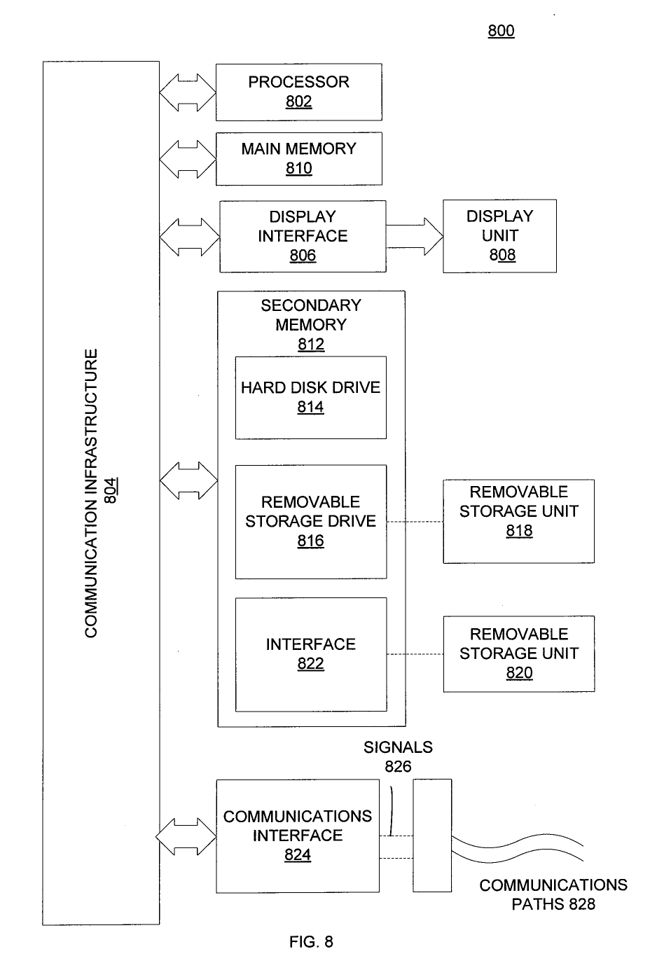

The computer system 800 includes a display interface 806 that forwards graphics, text, and other data from the communication infrastructure 804 (or from a frame buffer which is not shown in FIG. 8) for display on a display unit 808.

The computer system 800 further includes a main memory 810, such as random access memory (RAM), and may also include a secondary memory 812. The secondary memory 812 may further include, for example, a hard disk drive 814 and/or a removable storage drive 816, representing a floppy disk drive, a magnetic tape drive, an optical disk drive, etc. The removable storage drive 816 reads from and/or writes to a removable storage unit 818 in a well known manner. The removable storage unit 818 may represent a floppy disk, magnetic tape or an optical disk, and may be read by and written to by the removable storage drive 816. As will be appreciated, the removable storage unit 818 includes a computer usable storage medium having stored therein, computer software and/or data.

In accordance with various embodiments, the secondary memory 812 may include other similar devices for allowing computer programs or other instructions to be loaded into the computer system 800. Such devices may include, for example, a removable storage unit 820, and an interface 822. Examples of such may include a program cartridge and cartridge interface (such as that found in video game devices), a removable memory chip (such as an erasable programmable read only memory (EPROM), or programmable read only memory (PROM)) and associated socket, and other removable storage units 820 and interfaces 822, which allow software and data to be transferred from the removable storage unit 820 to the computer system 800.

The computer system 800 may further include a communication interface 824. The communication interface 824 allows software and data to be transferred between the computer system 800 and external devices. Examples of the communication interface 824 include, but may not be limited to a modem, a network interface (such as an Ethernet card), a communications port, a Personal Computer Memory Card International Association (PCMCIA) slot and card, and the like. Software and data transferred via the communication interface 824 are in the form of a plurality of signals, hereinafter referred to as signals 826, which may be electronic, electromagnetic, optical or other signals capable of being received by the communication interface 824. The signals 826 are provided to the communication interface 824 via a communication path (e.g., channel) 828. The communication path 828 carries the signals 826 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 816, a hard disk installed in hard disk drive 814, the signals 826, and the like. These computer program products provide software to the computer system 800. The present exemplary embodiment is directed to such computer program products.

Computer programs (also referred to as computer control logic) are stored in the main memory 810 and/or the secondary memory 812. Computer programs may also be received via the communication interface 804. Such computer programs, when executed, enable the computer system 800 to perform the features of the embodiments, as discussed herein. In particular, the computer programs, when executed, enable the processor 802 to perform the features of the present embodiment. Accordingly, such computer programs represent controllers of the computer system 800.

In accordance with an embodiment implemented using a software, the software may be stored in a computer program product and loaded into the computer system 800 using the removable storage drive 816, the hard disk drive 814 or the communication interface 824. The control logic (software), when executed by the processor 802, causes the processor 802 to perform the functions as described herein.

Another embodiment is implemented primarily in hardware using, for example, hardware components such as application specific integrated circuits (ASIC). Implementation of the hardware state machine so as to perform the functions described herein will be apparent to persons skilled in the relevant art(s). Yet another embodiment is implemented using a combination of both the hardware and the software.

While various embodiments have been described above, it should be understood that they have been presented by way of example, and not limitation. It will be apparent to persons skilled in the relevant art(s) that various changes in form and detail can be made therein without departing from the spirit and scope of the embodiments described herein. Thus, the present disclosure should not be limited by any of the above described exemplary embodiments, but should be defined only in accordance with the following claims and their equivalents.

In addition, it should be understood that the figures illustrated in the attachments, which highlight the functionality and advantages of the present disclosure, are presented for example purposes only. The architecture of the present disclosure is sufficiently flexible and configurable, such that it may be utilized (and navigated) in ways other than that shown in the accompanying figures.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
accessing, by a computer based system for a virtual world management system, a first virtual world program;
accessing, by the computer based system, a second virtual world program;
transferring, by the computer based system, points between the first virtual world program and the virtual world management system; and
transferring, by the computer based system, points between the second virtual world program and the virtual world management system.

2. The method of claim 1, wherein the first virtual world program is a first online game with a first membership account, and wherein the second virtual world program is a second online game with a second membership account.

3. The method of claim 2, wherein the first online game is different than the second online game.

4. The method of claim 2, wherein the accessing the first virtual world program comprises limited access to the first membership account associated with the first virtual world program.

5. The method of claim 4, wherein the first membership account associated with the first virtual world program is registered to a first user, and wherein the virtual world management system is registered to a second user.

6. The method of claim 5, wherein the first user is a child and wherein the second user is a parent.

7. The method of claim 1, wherein the points are at least one of currency, membership points, reward points, or loyalty points.

8. The method of claim 2, further comprising automatically transferring, by the computer based system, points from the virtual world management system to the first virtual world program in response to a points value of the first membership account falling below a threshold value.

9. The method of claim 2, further comprising transferring points from the virtual world management system to the first membership account of the first virtual world program based on a predetermined time period.

10. The method of claim 9, wherein the predetermined time period is at least one of weekly, monthly, or based on duration of time spent logged-on to the first or second virtual world program.

11. The method of claim 1, further comprising transferring points from the virtual world management system to the first virtual world program, wherein the amount of transferred points is a percentage of a total value stored in the virtual world management system.

12. The method of claim 7, wherein the virtual world management system is capable of exchanging multiple types of points using an exchange rate.

13. The method of claim 1, further comprising viewing, at the virtual world management system, individual account balances of the first virtual world and the second virtual world.

14. The method of claim 13, further comprising logging, at the virtual world management system, a spending history of the individual account balances of the first virtual world and the second virtual world.

15. The method of claim 5, wherein the first user is notified of changes to the first membership account initiated by the second user.

16. The method of claim 5, further comprising confirming, with the first user, that the points have been successfully transferred.

17. The method of claim 5, wherein the virtual world management system is authenticated prior to accessing the first virtual world program.

18. The method of claim 5, further comprising:
receiving, by the computer based system, member-defined conditions for the multiple virtual world accounts, wherein the member-defined conditions place limits on use of the multiple virtual world accounts;
receiving, by the computer based system, manager-defined conditions for the multiple virtual world accounts, wherein the manager-defined conditions place limits on use of the multiple virtual world accounts at the virtual world management system;
initiating, by the computer based system, a transfer of points using at least one of the multiple virtual world accounts;
receiving, by the computer based system, an authorization request from the at least one of the first virtual world program or the second virtual world program, the authorization request including at least one individual virtual world account identifier;
determining, by the computer based system, whether the transfer satisfies the member-defined conditions and the manager-defined conditions;
authorizing, by the computer based system, the transaction if the member-defined conditions and the manager-defined conditions are satisfied; and
denying, by the computer based system, the transaction if the member-defined conditions or the manager-defined conditions are not satisfied,
wherein at least one of the above steps is performed by a processor.

19. A non-transitory, tangible computer-readable storage medium having computer-executable instructions stored thereon that, if executed by a computer based system for managing a virtual world management system, cause the computer based system to perform operations comprising:
accessing, by the computer based system, a first virtual world program;
accessing, by the computer based system, a second virtual world program;
transferring, by the computer based system, points between the first virtual world program and the virtual world management system; and
transferring, by the computer based system, points between the second virtual world program and the virtual world management system.

20. A computer based system for managing a virtual world management system comprising:
a network interface communicating with a memory;
the memory configured to communicate with a processor for managing a virtual world management system; and
the processor, in response to executing a computer program, performs operations comprising:
accessing, by the processor, a first virtual world program;
accessing, by the processor, a second virtual world program;
transferring, by the processor, points between the first virtual world program and the virtual world management system; and
transferring, by the processor, points between the second virtual world program and the virtual world management system.
